(19) United States
(12) Patent Application Publication
(10) Pub. No.: US 2026/0089790 A1
(43) Pub. Date: Mar. 26, 2026

(54) MANAGEMENT OF COMMUNICATION TRAFFIC BETWEEN DISTRIBUTED UNIT AND RADIO UNIT IN O-RAN

(71) Applicant: Rakuten Symphony, Inc., Tokyo (JP)

(72) Inventors: Prasad Naga Krishna JAMPALA, Karnataka (IN); Sai Akash Samayamanthula, Karnataka (IN)

(73) Assignee: Rakuten Symphony, Inc., Tokyo (JP)

(21) Appl. No.: 19/276,191

(22) Filed: Jul. 22, 2025

(30) Foreign Application Priority Data
Sep. 25, 2024 (IN) 202441072447

(51) Int. Cl. H04W 76/25; H04W 76/10; H04W 92/12

(52) U.S. Cl. CPC H04W 76/25; H04W 76/10; H04W 92/12

(57) ABSTRACT

Embodiments disclosed herein provide a method and system for managing communication traffic between a radio unit (RU) 102 and a distributed unit (DU) 104 in an open-radio access network. The DU includes a primary RU managing component 106 and a secondary RU managing component 108. The DU 104 configures a communication channel 110 between the DU 104 and the RU 102. The DU 104 establishes the communication channel 110 for managing a communication traffic between the DU 104 and the RU 102 based on the configuration. The DU 104 monitors the communication channel 110 to determine whether a status of the communication channel 110 is inactive. The DU 104 dynamically transitions the management of the communication traffic from the primary RU managing component 106 to the secondary RU managing component 108 based on the determination that the communication channel 110 is inactive.

### CROSS-REFERENCE TO RELATED APPLICATION(S)

This application claims priority to Indian non-provisional patent application 202441072447, filed on Sep. 25, 2024, the entire contents of which are incorporated herein by reference.

### TECHNICAL FIELD

The present disclosure generally relates to the field of wireless communication, and more particularly relates to a method and an apparatus for managing communication traffic between radio unit (RU) and distributed unit (DU) in an open-radio access distributed network (O-RAN).

### BACKGROUND

The information disclosed in this background section is only for enhancement of understanding of the general background of the disclosure and should not be taken as an acknowledgement or any form of suggestion that this information forms the prior art already known to a person skilled in the art.

Open-Radio Access Network (O-RAN) technology is an evolved version of prior radio access networks to enable multiple vendors to provide hardware and/or software to a telecommunication system. The O-RAN disaggregates the RAN functions into a radio unit (RU), a distributed unit (DU), and a central unit (CU). The CU is a logical node for hosting radio resource control (RRC), service data adaptation protocol (SDAP) and/or packet data convergence protocol (PDCP) sublayers of the RAN. The DU is a logical node hosting Radio Link Control (RLC), Media Access Control (MAC), and Physical (PHY) sublayers of the RAN. The RU is a physical node that converts radio signals from antennas to digital signals that can be transmitted over FrontHaul to the DU. The DU, RU and SMO layers of O-RAN use management-plane (M-plane) connection for management and configuration purposes. A software application may be implemented to establish and maintain the M-plane connection between the RU and DU. Once the M-plane connection is established, the DU configures radio cells/carriers in the RU. After this configuration, data traffic flows in both the control plane and user plane are initiated. Maintaining the M-plane connection between the DU and RU continuously is critical to keeping the network operational. However, if the M-plane connection is lost between the DU and the RU, then the existing O-RAN architecture fails to provide a recovery process for a lost M-plane connection. The lost M-plane connection may lead to a complete outage of the network, and as a result, all radio cells would go down.

Accordingly, there is a need to maintain continuous M-plane connection between the DU, and RU in O-RAN systems.

### SUMMARY

The present disclosure relates to a method comprising the steps of configuring, by a Distributed Unit (DU), a primary Radio Unit (RU) managing component and a secondary RU managing component, associated with the DU, to establish a communication channel between the DU and an RU. Further, the communication channel is established, by the DU and based on the configuration, for managing a communication traffic between the DU and the RU. The communication traffic is managed by the primary RU managing component. The communication channel is monitored by the DU to determine whether a status of the communication channel is inactive. Further, the management of the communication traffic is dynamically transitioned from the primary RU managing component to the secondary RU managing component based on the determination that the communication channel is inactive.

The present disclosure also relates to an apparatus configured to configure, by a Distributed Unit (DU), a primary Radio Unit (RU) managing component and a secondary RU managing component, associated with the DU, to establish, by the DU and based on the configuration, a communication channel between the DU and an RU. Further, the communication channel is established for managing a communication traffic between the DU and the RU. The communication traffic is managed by the primary RU managing component. Further, the communication channel is monitored by the DU to determine whether the status of the communication channel is inactive. The management of the communication traffic is dynamically transitioned from the primary RU managing component to the secondary RU managing component based on the determination that the communication channel is inactive.

In an embodiment, there is a non-transitory computer readable medium including instructions stored thereon that when processed by at least one processor, cause the at least one processor to perform operations of configuring, by a Distributed Unit (DU), a primary Radio Unit (RU) managing component and a secondary RU managing component, associated with the DU, to establish a communication channel between the DU and an RU. Further, the communication channel is established, by the DU and based on the configuration, for managing a communication traffic between the DU and the RU. The communication traffic is managed by the primary RU managing component. The communication channel is monitored by the DU to determine whether the status of the communication channel is inactive. Further, the management of the communication traffic is dynamically transitioned from the primary RU managing component to the secondary RU managing component based on the determination that the communication channel is inactive.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates an exemplary environment for management of communication traffic between network entities of a wireless communication network, in accordance with some embodiments of the present disclosure.

FIG. 2 is a sequence diagram illustrating a scenario for management of communication traffic between network entities of a wireless communication network, in accordance with an embodiment of the present disclosure.

FIG. 3 shows an exemplary flow chart illustrating method steps for management of communication traffic between network entities of a wireless communication network, in accordance with some embodiments of the present disclosure.

FIG. 4 illustrates an embodiment of a device wherein the method for management of communication traffic between network entities of a wireless communication network, according to the embodiments as disclosed herein.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION OF THE DISCLOSURE

The following detailed description of example embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods described herein, may be implemented in different forms of hardware, software, or a combination of hardware and software. The actual specialized control hardware or software code used to implement these systems and/or methods is not limiting the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

In general, maintaining continuous management plane (M-plane) connection between a radio unit (RU) and a distributed unit (DU) is crucial in O-RAN network systems to provide high availability of radio cells. The M-plane connection is established and maintained by the DU through a RUMgr process. Further, the radio cells in the RU can be configured to initiate control plane and user plane traffic between the DU and RU. However, as stated earlier, in certain scenarios M-plane connection between the DU and RU is lost. In such scenarios, all radio cells shut down causing a network outage, reducing the high availability of the M-plane connection.

The methods and systems of the present disclosure solve a technical problem for providing the high availability of M-plane connection between DU and RU by implementing master-slave arrangement for the RUMgr process in the DU. Herein, techniques or mechanism may be required such that the high availability of M-plane connection between DU and RU may be performed with improved radio cells availability. The present disclosure solves this technical problem as described in the embodiments below.

Embodiments disclosed herein provide a method and system for configuring the M-plane connection between the RU and DU using the master process, such as a master RUMgr process, and the slave process, such as a slave RUMgr process, configured in the DU. Further, various embodiments disclosed herein allow initiating dynamic transition of management of a communication traffic between the DU and the RU, from the master process to the slave process, when the M-plane connection of the master process is lost with the RU. Therefore, the present disclosure suggests techniques for providing the high availability of M-plane connection using master-slave arrangement for the RUMgr process in the DU.

Thus, the present disclosure enables the high availability of M-plane connection with improved radio cells availability.

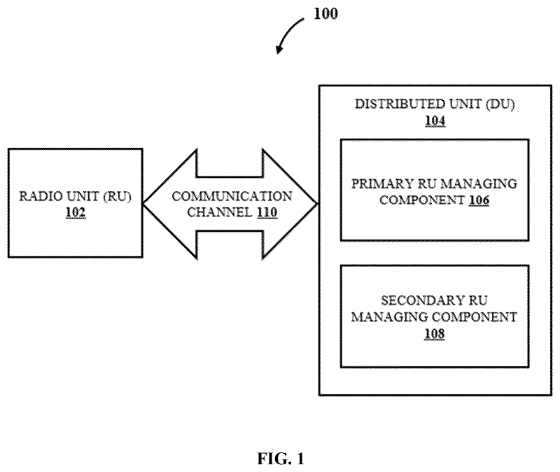

FIG. 1 illustrates an exemplary environment 100 for management of communication traffic between network entities of a wireless communication network, in accordance with some embodiments of the present disclosure. The wireless communication network is an open-radio access distributed network (O-RAN). The exemplary environment 100 comprises a radio unit (RU) 102 and a distributed unit (DU) 104 in the O-RAN.

The DU 104 and the RU 102 may be executed on a server system, for example, but not limited to, local server network(s) and/or cloud computing system(s). The DU 104 may refer to a logical node hosting Radio Link Control (RLC)/Media Access Control (MAC)/High-Physical (PHY) layers based on a lower layer functional split. The RU 102 may refer to a logical node hosting Low-PHY layer and RF processing based on a lower layer functional split. Management Plane (M-Plane) is a component of the O-RAN for configuration, monitoring, management and distribution of various services to all layers of O-RAN stack and other parts of the O-RAN system.

In an embodiment, the DU 104 comprises a primary Radio Unit (RU) managing component 106 and a secondary RU managing component 108. The primary RU managing component 106 and the secondary RU managing component 108, associated with the DU 104, may be software applications configured for managing the RU 102 and associated communication resources.

The DU 104 configures a communication channel 110 between the DU 104 and the RU 102. The communication channel 110 may be, for example, a common public radio interface (CPRI), enhanced common public radio interface (eCPRI), or a fronthaul interface. The communication channel 110 may utilize fiber optic links, microwave links, radio frequency (RF) links, satellite links, microwave backhaul, or ethernet to provide communication between the DU 104 and the RU 102.

In an embodiment, the DU 104 may configure the primary RU managing component 106 and the secondary RU managing component 108, associated with the DU 104, to establish the communication channel 110 between the DU 104 and an RU 102. In an embodiment, the primary RU managing component 106 and the secondary RU managing component 108 may be configured in a master-slave configuration. For example, the primary RU managing component 106 is designated with a master status, and the secondary RU managing component 108 is designated with a slave status.

In an embodiment, the DU 104 may establish the communication channel 110, based on the configuration, to manage a communication traffic between the DU 104 and the RU 102. In an example, embodiment, the communication traffic may be managed by the primary RU managing component 106. In some embodiments, to establish the communication channel 110 between the DU 104 and the RU 102, a primary m-plane connection may be established between the primary RU managing component 106 and the RU 102. In some embodiments, a secondary m-plane connection may be established between the secondary RU managing component 108 and the RU 102.

In an embodiment, the DU 104 monitors the communication channel 110 to determine whether a status of the communication channel 110 is inactive. In some embodiments, to monitor the communication channel 110, a status of the communication channel 110, established based on the primary RU managing component, may be synchronized with the secondary RU managing component 108. Further, the DU 104 may be configured to provide periodic status updates pertaining to the communication channel 110, established based on the primary RU managing component 106, to the secondary RU managing component 108.

In some embodiments, based on the periodic status updates, a disconnection of the communication channel 110 may be detected. Subsequently, based on the detection of the disconnection, it is determined that the status of the communication channel 110 is inactive.

In some embodiments, the DU 104 monitors a connection status between the primary RU managing component 106 and the secondary RU managing component 108. Further, the DU 104 may monitor a connection status between the RU 102 and the primary RU managing component 106. In some embodiments, the DU 104 may monitor a connection status between the RU 102 and the secondary RU managing component 108.

The DU 104 may also utilize other techniques for determining that the status of the communication channel 110 is inactive. In an example, upon detecting a re-establishing of the primary m-plane connection, the slave status is designated to the primary RU managing component 106.

In an embodiment, the DU 104 dynamically transitions the management of the communication traffic from the primary RU managing component 106 to the secondary RU managing component 108 based on the determination that the communication channel 110 is inactive.

In an embodiment, to dynamically transition the management of the communication traffic, the DU 104 re-establishes another communication channel between the secondary RU managing component 108 and the RU 102. Further, the DU 104 continues managing the communication traffic by the secondary RU managing component 108 using a pre-established communication channel. The status of the secondary RU managing component 108 is transitioned from the slave status to the master status.

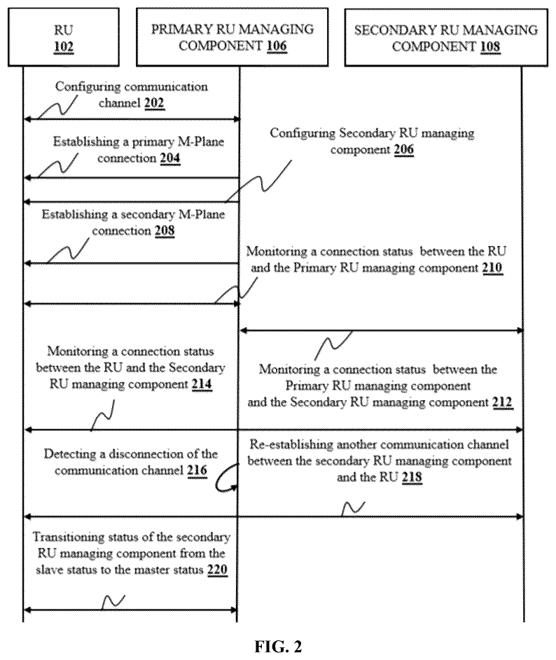

FIG. 2 is a sequence diagram illustrating a scenario for management of communication traffic between network entities of a wireless communication network, in accordance with an embodiment of the present disclosure. More specifically, FIG. 2 illustrates a signaling diagram for providing call home procedure in the DU 104 for managing communication traffic between the DU 104 and the RU 102.

At step 202, the primary RU managing component 106, associated with the DU 104, may be configured to establish the communication channel 110 between the DU 104 and the RU 102. The communication channel 110 may be established by the DU 104 based on the configuration for managing a communication traffic between the DU 104 and the RU 102. The primary RU managing component 106 may manage the communication traffic.

At step 204, a primary m-plane connection may be established between the primary RU managing component 106 and the RU 102.

At step 206, the primary RU managing component 106 may configure the secondary RU managing component 108. In some embodiments, the primary RU managing component 106 and the secondary RU managing component 108 may be configured in a master-slave configuration.

At step 208, a secondary m-plane connection may be established, by the primary RU managing component 106, between the secondary RU managing component 108 and the RU 102.

In an embodiment, a status of the communication channel established by the primary RU managing component 106 may be synchronized with the secondary RU managing component 108. Further, periodic status updates pertaining to the communication channel established by the primary RU managing component 106 may be provided to the secondary RU managing component 108.

In an embodiment, when the primary RU managing component 106 and the secondary RU managing component 108 are configured in the master-slave configuration, a master status may be designated to the primary RU managing component 106. Thereafter, a slave status may be designated to the secondary RU managing component 108.

At step 210, a connection status between the RU 102 and the primary RU managing component 106 may be monitored.

At step 212, a connection status between the primary RU managing component 106 and the secondary RU managing component 108 may be monitored.

At step 214, a connection status between the RU 102 and the secondary RU managing component 108 may be monitored.

In an embodiment, the DU 104 may monitor the communication channel to determine whether a status of the communication channel is inactive.

At step 216, a disconnection of the communication channel may be detected based on the periodic status updates. Further, the DU 104 may determine that the status of the communication channel is inactive based on the detection.

In an embodiment, the management of the communication traffic from the primary RU managing component 106 to the secondary RU managing component 108 may be dynamically transitioned based on the determination that the communication channel is inactive.

At step 218, another communication channel between the secondary RU managing component 108 and the RU 102 may be re-established. Thereafter, in some embodiments, the management of the communication traffic may be continued by the secondary RU managing component 108 using a pre-established communication channel.

At step 220, the status of the secondary RU managing component 108 may be transitioned from the slave status to the master status to dynamically transitioned the management of the communication traffic from the primary RU managing component 106 to the secondary RU managing component 108.

In an embodiment, upon detecting the re-establishment of the primary m-plane connection, the slave status may be designated to the primary RU managing component 106.

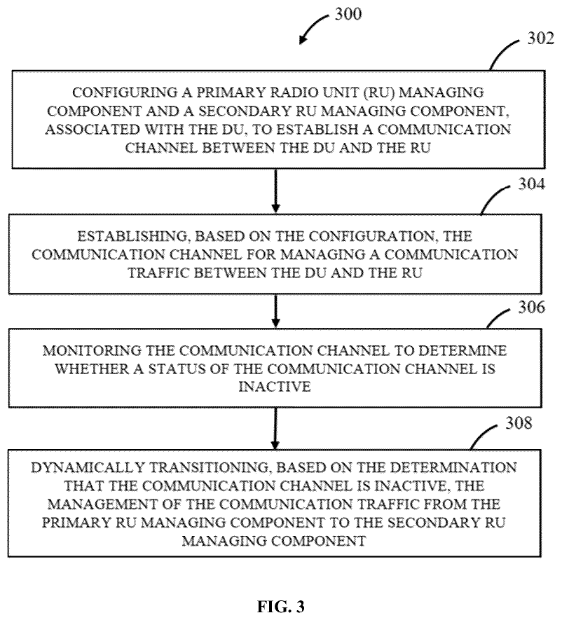

FIG. 3 shows an exemplary flow chart illustrating method steps for management of communication traffic between network entities of a wireless communication network, in accordance with some embodiments of the present disclosure. More specifically, FIG. 3 illustrates an exemplary flow chart illustrating method steps for managing communication traffic between the DU 104 and the RU 102.

As illustrated in FIG. 3, the method 300 may comprise one or more steps. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 302, the primary RU managing component 106 and the secondary RU managing component 108, associated with the DU 104, may be configured to establish the communication channel 110 between the DU 104 and the RU 102. For example, the primary RU managing component 106 and the secondary RU managing component 108 may be configured as RUMgr processes.

At step 304, the communication channel 110 may be established, by the DU 104 and based on the configuration, for managing a communication traffic between the DU 104 and the RU 102. The communication traffic is managed by the primary RU managing component 106.

In a preferred embodiment, a primary m-plane connection may be established between the primary RU managing component 106 and the RU 102. Thereafter, a secondary m-plane connection may be established between the secondary RU managing component 108 and the RU 102.

In an alternate embodiment, the primary RU managing component 106 and the secondary RU managing component 108 may be configured in a master-slave configuration. Thereafter, a master status may be designated to the primary RU managing component 106, and a slave status may be designated to the secondary RU managing component 108.

At step 306, the DU 104 may monitor the communication channel 110 to determine whether a status of the communication channel 110 is inactive.

In an embodiment, a status of the communication channel 110 established based on the primary RU managing component 106, may be synchronized with the secondary RU managing component 108. Further, periodic status updates pertaining to the communication channel 110 established based on the primary RU managing component 106 may be provided to the secondary RU managing component 108.

In an embodiment, a connection status between the primary RU managing component 106 and the secondary RU managing component 108 may be monitored. For example, the secondary RU managing component 108 monitors the connection status using a heartbeat mechanism. Thereafter, a connection status between the RU 102 and the primary RU managing component 106 may be monitored. For example, the secondary RU managing component 108 periodically monitors the connection status using a supervision process. Further, a connection status between the RU 102 and the secondary RU managing component 108 may be monitored. For example, the secondary RU managing component 108 periodically monitors the connection status using the supervision process.

At step 308, the management of the communication traffic from the primary RU managing component 106 to the secondary RU managing component 108 may be dynamically transitioned based on the determination that the communication channel 110 is inactive.

In another embodiment, a disconnection of the communication channel 110 may be detected based on the periodic status updates. Further, based on the detection, the DU 104 may determine the status of the communication channel 110 is inactive.

In an embodiment, the dynamically transitioning of the management of the communication traffic may include re-establishing another communication channel between the secondary RU managing component 108 and the RU 102. Thereafter, the management of the communication traffic may be continued by the secondary RU managing component 108 using a pre-established communication channel.

In an embodiment, the status of the secondary RU managing component 108 may be transitioned from the slave status to the master status.

In an embodiment, upon detecting a re-establishing of the primary m-plane connection, the primary RU managing component 106 may be designated with the slave status.

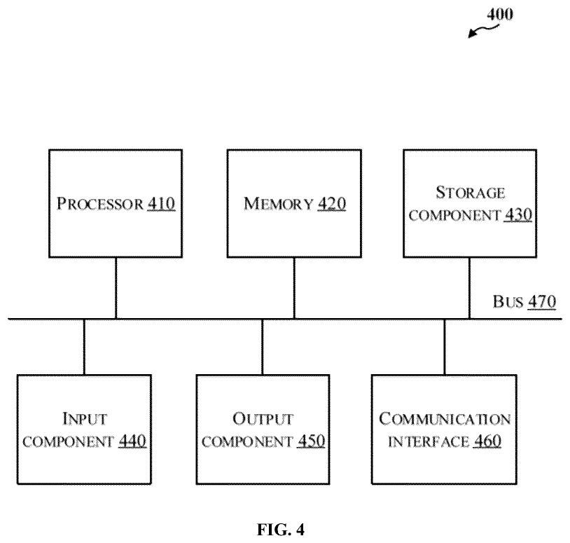

FIG. 4 illustrates an embodiment of a device 400 wherein the method for management of communication traffic between network entities of a wireless communication network, may be implemented, according to the embodiments as disclosed herein. It will be appreciated that the device 400 is associated with the DU 104. As shown in FIG. 4, the device 400 comprises a processor 410, a memory 420, a storage component 430, an input component 440, an output component 450, a communication interface 460, and a bus 470.

The processor 410, as used herein, means any type of computational circuit that may comprise hardware elements and software elements. The processor 410 may be embodied as a multi-core processor, a single core processor, or a combination of one or more multi-core processors and/or one or more single core processors, a distributed processing system, or the like. The processor 410 may be a Central Processing Unit (CPU), a graphics processing unit (GPU), an accelerated processing unit (APU), an application-specific integrated circuit (ASIC), or another type of processing component.

Memory 420 includes a non-transitory computer readable medium. Memory 420 includes a random-access memory (RAM), a read only memory (ROM), and/or another type of dynamic or static storage device (e.g., a flash memory, a magnetic memory, and/or an optical memory) that stores information and/or instructions for use by processor 410. The memory 420 comprises machine-readable instructions which are executable by the processor 410. These machine-readable instructions when executed by the processor 410 cause the processor 410 to perform one or more method steps of an embodiment described above.

Storage component 430 stores information and/or software related to the operation and use of the device 400. For example, storage component 430 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 440 is configured to receive information, such as, but not limited to, traffic information, communication channel parameters, and the like. For example, the input component 440 may include, but not be limited to, a touch screen display, a keyboard, a keypad, a mouse, a button, a switch, and/or a microphone. Additionally, or alternatively, the input component 440 may include a sensor for sensing information (e.g., a global positioning system (GPS), an accelerometer, a gyroscope, and/or an actuator).

Output component 450 is configured to provide output information from the device 400. For example, the output component 450 may be, but not limited to, a display, a speaker, instructions to an external device, and/or one or more light-emitting diodes (LEDs).

Communication interface 460 is an interface that provides a communication connection to other devices, such as external devices and internal devices. The connection by the communication interface 460 can be a wired connection, a wireless connection, or a combination of wired and wireless connections, and can be a direct connection or an indirect connection via a communication network that exists between the device 400 and other devices. In other words, the standard of the communication interface 460 is not limited.

The bus 470 acts as an interconnect between the processor 410, the memory 420, the storage component 430, the input component 440, the output component 450, and the communication interface 460 of the device 400. The bus 470 may include a wired interconnection or a wireless interconnection.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400. Further, one or more method steps described in any of the embodiments may be performed utilizing a plurality of devices 400 in communication with one another.

In an embodiment [1], a method comprises: configuring, by a Distributed Unit (DU), a primary Radio Unit (RU) managing component and a secondary RU managing component, associated with the DU, to establish a communication channel between the DU and an RU; establishing, by the DU and based on the configuration, the communication channel for managing a communication traffic between the DU and the RU, wherein the communication traffic is managed by the primary RU managing component; monitoring, by the DU, the communication channel to determine whether a status of the communication channel is inactive; and dynamically transitioning, based on the determination that the communication channel is inactive, the management of the communication traffic from the primary RU managing component to the secondary RU managing component.

In an embodiment [2], the monitoring of the communication channel, described in the embodiment [1], comprises: synchronizing, with the secondary RU managing component, a status of the communication channel established based on the primary RU managing component; and providing, to the secondary RU managing component, periodic status updates pertaining to the communication channel established based on the primary RU managing component.

In an embodiment [3], the method, described in the embodiment [2], further comprises: detecting, based on the periodic status updates, a disconnection of the communication channel; and determining, based on the detection, that the status of the communication channel is inactive.

In an embodiment [4], the dynamically transitioning of the management of the communication traffic, described in the embodiment [1], further comprises one of: re-establishing another communication channel between the secondary RU managing component and the RU; and continuing the management of the communication traffic by the secondary RU managing component using a pre-established communication channel.

In an embodiment [5], the configuring of the primary RU managing component and the secondary RU managing component, described in the embodiment [1], further comprises: configuring of the primary RU managing component and the secondary RU managing component in a master-slave configuration; designating a master status to the primary RU managing component; and designating a slave status to the secondary RU managing component.

In an embodiment [6], the dynamically transitioning of the management of the communication traffic, described in the embodiment [5], comprises: transitioning the status of the secondary RU managing component from the slave status to the master status.

In an embodiment [7], the establishing of the communication channel between the DU and the RU, described in the embodiment [6], comprises: establishing a primary m-plane connection between the primary RU managing component and the RU; and establishing a secondary m-plane connection between the secondary RU managing component and the RU.

In an embodiment [8], in the method, described in the embodiment [7], upon detecting a re-establishing of the primary m-plane connection, designating the slave status to the primary RU managing component.

In an embodiment [9], in the method, described in the embodiment [1], monitoring a connection status between the primary RU managing component and the secondary RU managing component; monitoring a connection status between the RU and the primary RU managing component; and monitoring a connection status between the RU and the secondary RU managing component.

In an embodiment [10], an apparatus is configured to: configure, by a Distributed Unit (DU), a primary Radio Unit (RU) managing component and a secondary RU managing component, associated with the DU, to establish a communication channel between the DU and an RU; establish, by the DU and based on the configuration, the communication channel for managing a communication traffic between the DU and the RU, wherein the communication traffic is managed by the primary RU managing component; monitor, by the DU, the communication channel to determine whether a status of the communication channel is inactive; and dynamically transition, based on the determination that the communication channel is inactive, the management of the communication traffic from the primary RU managing component to the secondary RU managing component.

In an embodiment [11], to monitor the communication channel, the apparatus, described in the embodiment [10], is further configured to: synchronize, with the secondary RU managing component, a status of the communication channel established based on the primary RU managing component; and provide, to the secondary RU managing component, periodic status updates pertaining to the communication channel established based on the primary RU managing component.

In an embodiment [12], the apparatus, described in the embodiment [11], is further configured to: detect, based on the periodic status updates, a disconnection of the communication channel; and determine, based on the detection, that the status of the communication channel is inactive.

In an embodiment [13], to dynamically transition the management of the communication traffic, the apparatus, described in the embodiment [10], is further configured to: re-establish another communication channel between the secondary RU managing component and the RU; and continue the management of the communication traffic by the secondary RU managing component using a pre-established communication channel.

In an embodiment [14], to configure the primary RU managing component and the secondary RU managing component, the apparatus, described in the embodiment [10], is further configured to: configure the primary RU managing component and the secondary RU managing component in a master-slave configuration; designate a master status to the primary RU managing component; and designate a slave status to the secondary RU managing component.

In an embodiment [15], to dynamically transition the management of the communication traffic, the apparatus, described in the embodiment [14], is further configured: to transition the status of the secondary RU managing component from the slave status to the master status.

In an embodiment [16], to establish the communication channel between the DU and the RU, the apparatus, described in the embodiment [15], is further configured to: establish a primary m-plane connection between the primary RU managing component and the RU; and establish a secondary m-plane connection between the secondary RU managing component and the RU.

In an embodiment [17], upon detecting a re-establishing of the primary m-plane connection, the apparatus, described in the embodiment [16], is configured to designate the slave status to the primary RU managing component.

In an embodiment [18], the apparatus, described in the embodiment [10], is further configured to: monitor a connection status between the primary RU managing component and the secondary RU managing component; monitor a connection status between the RU and the primary RU managing component; and monitor a connection status between the RU and the secondary RU managing component.

In an embodiment [19], a non-transitory computer-readable medium having program instructions stored thereon, executed by an apparatus for wireless communication, is disclosed. The program instructions may comprise: configuring, by a Distributed Unit (DU), a primary Radio Unit (RU) managing component and a secondary RU managing component, associated with the DU, to establish a communication channel between the DU and an RU; establishing, by the DU and based on the configuration, the communication channel for managing a communication traffic between the DU and the RU, wherein the communication traffic is managed by the primary RU managing component; monitoring, by the DU, the communication channel to determine whether a status of the communication channel is inactive; and dynamically transitioning, based on the determination that the communication channel is inactive, the management of the communication traffic from the primary RU managing component to the secondary RU managing component.

In a non-limiting embodiment of the present disclosure, one or more non-transitory computer-readable media may be utilized for implementing the embodiments consistent with the present disclosure. A computer-readable medium refers to any type of physical memory (such as the memory 420) on which information or data readable by a processor may be stored. Thus, a computer-readable media may store one or more instructions for execution by the at least one processor 410, including instructions for causing the at least one processor 410 to perform steps or stages consistent with the embodiments described herein. The term “computer-readable media” should be understood to include tangible items and exclude carrier waves and transient signals. By way of example, and not limitation, such computer-readable media can comprise Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

Thus, certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

The various illustrative logical blocks, modules, and operations described in connection with the present disclosure may be implemented or performed with a general-purpose processor, discrete gate or transistor logic, discrete hardware components or any combination thereof designed to perform the functions described herein. A general-purpose processor may include a microprocessor, but in the alternative, the processor may include any commercially available processor, controller, microcontroller, or state machine. A processor may also be implemented as a combination of computing devices, e.g., a plurality of microprocessors, or any other such configuration.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. A method comprising:
configuring, by a Distributed Unit (DU), a primary Radio Unit (RU) managing component and a secondary RU managing component, associated with the DU, to establish a communication channel between the DU and an RU;
establishing, by the DU and based on the configuration, the communication channel for managing a communication traffic between the DU and the RU, wherein the communication traffic is managed by the primary RU managing component;
monitoring, by the DU, the communication channel to determine whether a status of the communication channel is inactive; and
dynamically transitioning, based on the determination that the communication channel is inactive, the management of the communication traffic from the primary RU managing component to the secondary RU managing component.

2. The method as claimed in claim 1, wherein the monitoring of the communication channel comprises:
synchronizing, with the secondary RU managing component, a status of the communication channel established based on the primary RU managing component; and
providing, to the secondary RU managing component, periodic status updates pertaining to the communication channel established based on the primary RU managing component.

3. The method as claimed in claim 2, further comprising:
detecting, based on the periodic status updates, a disconnection of the communication channel; and
determining, based on the detection, that the status of the communication channel is inactive.

4. The method as claimed in claim 1, wherein the dynamically transitioning of the management of the communication traffic comprises one of:
re-establishing another communication channel between the secondary RU managing component and the RU; and
continuing the management of the communication traffic by the secondary RU managing component using a pre-established communication channel.

5. The method as claimed in claim 1, wherein, the configuring of the primary RU managing component and the secondary RU managing component comprises:
configuring the primary RU managing component and the secondary RU managing component in a master-slave configuration;
designating a master status to the primary RU managing component; and
designating a slave status to the secondary RU managing component.

6. The method as claimed in claim 5, wherein, the dynamically transitioning of the management of the communication traffic, comprises:
transitioning the status of the secondary RU managing component from the slave status to the master status.

7. The method as claimed in claim 6, wherein the establishing of the communication channel between the DU and the RU, comprises:
establishing a primary m-plane connection between the primary RU managing component and the RU; and
establishing a secondary m-plane connection between the secondary RU managing component and the RU.

8. The method as claimed in claim 7, upon detecting a re-establishing of the primary m-plane connection, designating the slave status to the primary RU managing component.

9. The method as claimed in claim 1, further comprises:
monitoring a connection status between the primary RU managing component and the secondary RU managing component;
monitoring a connection status between the RU and the primary RU managing component; and
monitoring a connection status between the RU and the secondary RU managing component.

10. An apparatus configured to:
configure, by a Distributed Unit (DU), a primary Radio Unit (RU) managing component and a secondary RU managing component, associated with the DU, to establish a communication channel between the DU and an RU;
establish, by the DU and based on the configuration, the communication channel for managing a communication traffic between the DU and the RU, wherein the communication traffic is managed by the primary RU managing component;
monitor, by the DU, the communication channel to determine whether a status of the communication channel is inactive; and
dynamically transition, based on the determination that the communication channel is inactive, the management of the communication traffic from the primary RU managing component to the secondary RU managing component.

11. The apparatus as claimed in claim 10, wherein, to monitor the communication channel, the apparatus is configured to:
synchronize, with the secondary RU managing component, a status of the communication channel established based on the primary RU managing component; and
provide, to the secondary RU managing component, periodic status updates pertaining to the communication channel established based on the primary RU managing component.

12. The apparatus as claimed in claim 11, wherein the apparatus is further configured to:
detect, based on the periodic status updates, a disconnection of the communication channel; and
determine, based on the detection, that the status of the communication channel is inactive.

13. The apparatus as claimed in claim 10, wherein, to dynamically transition the management of the communication traffic, the apparatus is further configured to:
re-establish another communication channel between the secondary RU managing component and the RU; and
continue the management of the communication traffic by the secondary RU managing component using a pre-established communication channel.

14. The apparatus as claimed in claim 10, wherein, to configure the primary RU managing component and the secondary RU managing component, the apparatus is configured to:
configure the primary RU managing component and the secondary RU managing component in a master-slave configuration;
designate a master status to the primary RU managing component; and
designate a slave status to the secondary RU managing component.

15. The apparatus as claimed in claim 14, wherein, to dynamically transition the management of the communication traffic, the apparatus is configured to:
transition the status of the secondary RU managing component from the slave status to the master status.

16. The apparatus as claimed in claim 15, wherein, to establish the communication channel between the DU and the RU, the apparatus is configured to:
establish a primary m-plane connection between the primary RU managing component and the RU; and
establish a secondary m-plane connection between the secondary RU managing component and the RU.

17. The apparatus as claimed in claim 16, wherein, upon detecting a re-establishing of the primary m-plane connection, the apparatus is configured to designate the slave status to the primary RU managing component.

18. The apparatus as claimed in claim 10, further comprising:
monitor a connection status between the primary RU managing component and the secondary RU managing component;
monitor a connection status between the RU and the primary RU managing component; and
monitor a connection status between the RU and the secondary RU managing component.

19. A non-transitory computer-readable medium having program instructions stored thereon, executed by an apparatus for wireless communication, for:
configuring, by a Distributed Unit (DU), a primary Radio Unit (RU) managing component and a secondary RU managing component, associated with the DU, to establish a communication channel between the DU and an RU;
establishing, by the DU and based on the configuration, the communication channel for managing a communication traffic between the DU and the RU, wherein the communication traffic is managed by the primary RU managing component;
monitoring, by the DU, the communication channel to determine whether a status of the communication channel is inactive; and
dynamically transitioning, based on the determination that the communication channel is inactive, the management of the communication traffic from the primary RU managing component to the secondary RU managing component.
